(19) United States
(12) Patent Application Publication
(10) Pub. No.: US 2014/0257926 A1
(43) Pub. Date: Sep. 11, 2014

(54) SYSTEMS AND METHODS FOR MOBILE POINT-OF-SALE PROCESS MANAGEMENT

(71) Applicant: PAUL B. RASBAND, Lantana, FL (US)

(72) Inventor: PAUL B. RASBAND, Lantana, FL (US)

(73) Assignee: Tyco Fire & Security GmbH, Neuhausen Am Rheinfall (CH)

(21) Appl. No.: 14/193,013

(22) Filed: Feb. 28, 2014

Related U.S. Application Data
(60) Provisional application No. 61/776,065, filed on Mar. 11, 2013.

(51) Int. Cl. G06Q 30/02

(52) U.S. Cl. CPC G06Q 30/0202
USPC 705/7.31

(57) ABSTRACT

Systems (100) and methods (800) for managing Mobile Point Of Sale (“MPOS”) services of a retail store (102). The methods involve obtaining customer information specifying sensed activities and locations of customers (114) currently present in the retail store. Next, customer demands of the MPOS services are predicted based on the customer information. The MPOS services facilitate a purchase transaction by a customer for purchasing at least one item (116) offered for sale within the retail store. Thereafter, the MPOS services are managed based at least on the predicted customer demands of the MPOS services. Additionally, the MPOS services can be further managed based on employee information specifying sensed activities and locations of employees (150) within the retail store.

### CROSS REFERENCE TO RELATED APPLICATIONS

This application claims the benefit of U.S. Provisional Patent Application Ser. No. 61/776,065 filed Mar. 11, 2013, which is herein incorporated by reference.

### FIELD OF THE INVENTION

This document relates generally to systems and methods for Mobile Point-Of-Sale (“MPOS”) process management. More particularly, this document relates to systems and methods for retail shopper surveillance facilitating the management of a mobile POS process.

### BACKGROUND OF THE INVENTION

In order to make MPOS solutions practical inside retail store settings, customers who wish to pay for their selected items must be able to find a sales associate who has authority and means to perform a MPOS transaction. From the retailer's perspective, employee productivity is increased when the employees currently assigned to MPOS duties can quickly find store customers ready to checkout. If waiting or line queuing is involved in this process, much of the purpose of the MPOS service is defeated. Thus, retailers wishing to implement MPOS services in their retail stores are faced with the problem of getting together in a timely and labor efficient manner the MPOS staff on duty and the customers ready to use the MPOS service. This problem must be solved in a manner which is convenient and unobtrusive from the perspective of the retailers. No known solutions to this particular problem exist, as MPOS is a relatively new practice in retail stores.

### SUMMARY OF THE INVENTION

The present invention concerns implementing systems and methods for managing MPOS services of a retail store. The methods involve obtaining customer information specifying sensed activities and locations of customers currently present in the retail store. Next, customer demands of the MPOS services are predicted based on the customer information. The MPOS services facilitate a purchase transaction by a customer for purchasing at least one item offered for sale within the retail store. The MPOS services are then managed based on the predicted customer demands thereof.

The customer demands can be predicted based on the results of at least one determination of the following determinations: how many individual customers are currently inside the retail store; where each customer is currently located and/or has been located within the retail store relative to a reference point, each other and/or at least one store employee; which sectors of the retail store have been visited by each customer; how long has each customer been in each sector of the retail store; how many sectors of the retail store have not been visited by each customer; which direction is each moving customer traveling; how many items offered for sale by the retail store are currently possessed by each customer; and a most likely sector of the retail store which will be visited by each customer.

Additionally or alternatively, the customer demands can be predicted based on an estimated time until each customer requires the MPOS services and/or a detected pattern of movement for each customer. The estimated time is determined based on at least one of the customer information and historical data relating to previous shopping activities by the customer within the retail store. The pattern of movement is detected based on the customer information and calibration patterns.

The customer demands may further be predicted based on results of a determination as to whether a period of time in which a customer has been in a given sector of the retail store exceeds a threshold value. If it is determined that the period of time exceeds the threshold value, then an employee of the retail store may be deployed to the given sector.

In some scenarios, the methods also involve obtaining employee information specifying activities and locations of employees currently present in the retail store. The MPOS services may then be further managed based on the employee information. Such management can be achieved by making at least determination of the following determinations based on the employee information: where each employee is located and/or has been located within the retail store relative to a reference point, other store employees, and/or at least one customer; which direction each moving store employee is traveling; how long each store employee has been in a given location within or sector of the retail store; which store employees are currently handling an MPOS transaction; which customers have requested MPOS services from a store employee; which customers are currently being provided MPOS services by respective store employees; what is a status of each currently pending MPOS transaction; which store employees are currently available and/or best suited to provide MPOS services to customer; and which routes through the retail store each store employee should take so as to ensure that MPOS services are provided to customers in a reasonable amount of time.

### DESCRIPTION OF THE DRAWINGS

Embodiments will be described with reference to the following drawing figures, in which like numerals represent like items throughout the figures, and in which:

FIG. 1 is a schematic illustration of an exemplary retail store system that is useful for understanding the present invention.

FIG. 2 is a schematic illustration of an exemplary network architecture for the sensors and data collection system of FIG. 1.

FIG. 3 is a block diagram of an exemplary architecture for a sensor that is useful for understanding the present invention.

FIG. 4 is a schematic illustration of an exemplary architecture for the analytics system shown in FIG. 1.

FIG. 5 is a schematic illustration that is useful for understanding an exemplary pattern.

FIG. 6 is a schematic illustration of an exemplary architecture for the MPOS management system shown in FIG. 1.

FIG. 7 is a schematic illustration of an exemplary architecture for the MPOS device shown in FIG. 1.

FIG. 8 is a flow diagram of an exemplary method for managing MPOS services of a retail store that is useful for understanding the present invention.

### DETAILED DESCRIPTION OF THE INVENTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

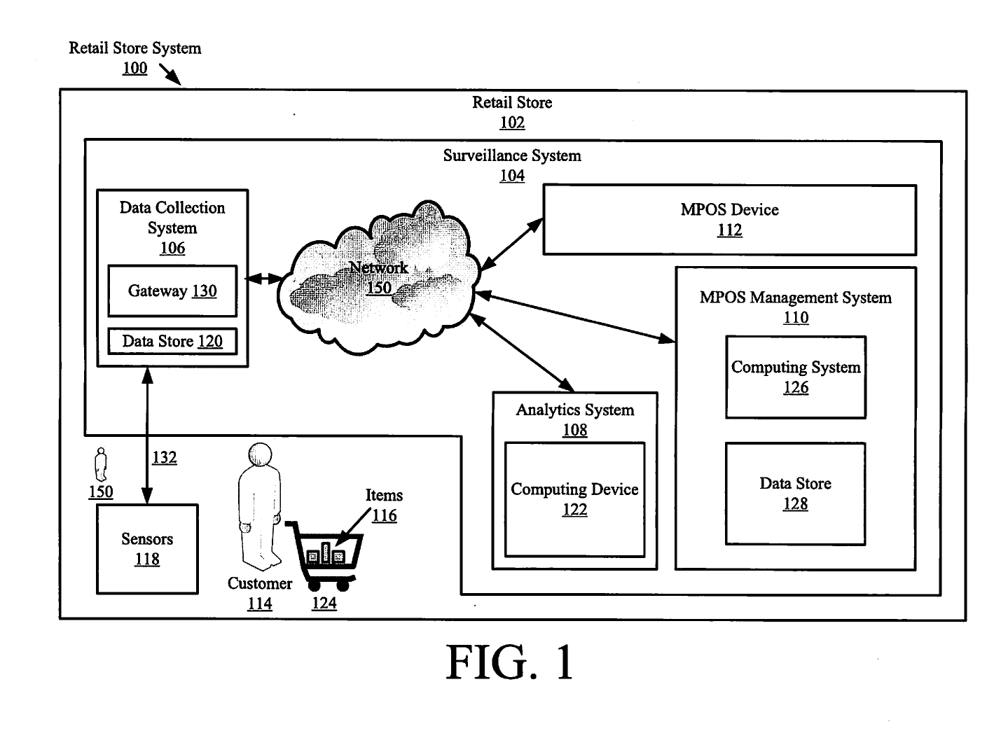

Embodiments will now be described with respect to FIGS. 1-7. Embodiments generally relate to novel systems and methods for managing MPOS services of a retail store. The methods involve obtaining customer information specifying sensed activities and locations of customers currently present in the retail store, and/or employee information specifying activities and locations of employees currently present in the retail store. Next, customer demands of the MPOS services are predicted based on the customer information. The MPOS services facilitate a purchase transaction by a customer for purchasing at least one item offered for sale within the retail store. The MPOS services are then managed based on the predicted customer demands thereof and/or employee information.

Referring now to FIG. 1, there is provided a schematic illustration of an exemplary Retail Store System (“RSS”) 100 that is useful for understanding the present invention. RSS 100 is generally configured to detect and track the activities and locations of customers 114 and/or store employees 150 within a retail store 102. This tracked information is then used to manage MPOS services of the retail store 102. MPOS services are well known in the art, and therefore will not be described herein. Any known or to be known MPOS services can be employed herein without limitation. Accordingly, the RSS 100 comprises a Surveillance System (“SS”) 104 including a Data Collection System (“DCS”) 106, an analytics system 108, an MPOS management system 110 and at least one MPOS device 112. Although the listed components 104, 106, 108, 110 and 112 are shown as being located in the retail store 102, embodiments of the present invention are not limited in this regard. One or more of these components can alternatively be located at a remote site.

The DCS 106 is responsible for collecting data on the movement, activities and position of customers 114 and/or store employees 150 inside the retail store 102. The data can be collected using sensors 118 disposed at various locations within the retail store 102. The sensors 118 can include, but are not limited to, proximity sensors, motion detection sensors, Short Range Communication (“SRC”) devices, Radio Frequency (“RF”) devices, and/or video based sensing devices. Each of the listed types of sensor is well known in the art, and therefore will not be described herein. Any known or to be known type of listed sensor can be used herein without limitation. Notably, the SRC devices, RF devices and/or video based sensing devices facilitate the identification of each customer and/or employee in the retail store 102. For example, the RF devices can communicate with mobile communication devices (e.g., cellular phones) of the customers/employees to obtain identifier information therefrom. Alternatively or additionally, the RF devices can communicate with RF Identifier (“RFID”) devices coupled to shopping cart/baskets 124, items 116 offered for sale within the retail store 102, and/or swipe cards or barcode equipped cards issued to customers/employees of the retail store.

During operation, the sensors 118 forward the collected data to a gateway 130 of the DCS 106 for at least temporary storage in a data store 120 (e.g., a database). Gateways are well known in the art, and therefore will not be described herein. Any known or to be known gateway architecture can be used herein without limitation. In all cases, the communications between sensors 118 and gateway 130 can be made over wired communication links 132 and/or wireless communications links (not shown) using any suitable communications protocol, as will be described in detail below. The collected data can be sent in any suitable format continuously or periodically from the sensors 118. For example, the collected data is periodically sent from the sensors 118 is a report format. Thereafter, the stored data is sent from the gateway 130 to the analytics system 108 and/or MPOS management system 110 via a network 150. Network 150 can include a private network (e.g., a Local Area Network (“LAN”)) and/or a public network (e.g., the Internet).

The analytics system 108 comprises a computing device 122. The computing device 122 is generally configured to process customer related information obtained by the sensors 118 and/or other sources for making the following determinations: how many individual customers 114 are inside the retail store 102; where each customer 114 is located and/or has been located within the retail store 102 relative to a reference point, each other and/or at least one store employee; to which sectors of the retail store each customer and/or store employee have visited; how long each customer and/or employee has been in each sector; a number of sectors of the retail store which have not been visited by each customer; the direction in which each customer 114 is traveling; how many items each customer has in his/her shopping car, shopping basket or hands; a most likely sector of the retail store which will be visited by each customer; and/or an estimated time until each customer requires MPOS services. The estimated time may be determined based on recently received data from sensors 118 and/or historical data associated with the customer (e.g., data indicating various parameters of previous shopping experiences by the same customer, such as number of items purchased, types of items purchased, routes taken through the retail store, date of last purchase transaction, and/or average time periods between purchase transactions).

The computing device 122 also processes the data received from the DCS 106 to: (a) detect and eliminate redundant data, and/or use data redundancy to improve customer location and behavior estimation; (b) compile the data received from sensors 118 and/or other data according to a pre-defined set of parameters or rules so as to generate customer reports and/or statistical reports; (c) detect patterns of movement defined by recently received data and historical data; and/or (d) compare the detected patterns to calibration patterns (e.g., pre-defined calibration patterns and/or learned calibration patterns obtained using artificial intelligence and pattern recognition technology). The data aggregate reports may include information specifying: customer identifiers; present and/or past locations of customers inside the retail store; how long each customer has been inside the retail store; how many sectors of the retail store each customer has or has not visited; which sectors of the retail store each customer has or has not visited; at least one direction of travel for each customer; item identifiers; how many items each customer currently possess; a most likely sector of the retail store which will be visited by each customer; and/or an estimate time until each customer requires MPOS services. The analytics system 108 provides the customer reports to the MPOS management system 110 via network 150. The customer reports are stored in a data store 128 of the MPOS management system 110.

The MPOS management system 110 is also configured to generate employee reports. In this regard, the MPOS management system 110 comprises a computing system 126. The computing system 126 is generally configured to receive and process employee related information to make certain determinations. The determinations can include, but is not limited to, the following: where each employee is located and/or has been located within the retail store 102 relative to a reference point, other store employees, and/or a customer; the direction of travel each store employee is traveling; how long each store employee has been in a given location within a sector of the retail store; which store employees are currently handling an MPOS transaction; which customers have requested and/or are being provided MPOS services; what is the status of each currently pending MPOS transaction; which store employees are currently available and/or best suited to provide MPOS services to customer; and/or which routes through the retail store each store employee should take so as to ensure that MPOS services are provided to customers in a reasonable amount of time. These determinations can be made using employee related information received from sensors 118 and/or from MPOS devices 112 possessed by the store employees.

Thereafter, the customer and/or employee reports are used by a computing system 126 of the MPOS management system 110 to facilitate the management of MPOS services provided by the retail store 102. By tracking customer and/or employee status and locations in the retail store, MPOS process demands can be predicted such that store employees can be deployed to areas of the retail store where MPOS services are likely needed by customers. Such areas of the retail store can be identified using pre-defined algorithms and rules. For example, an area of the retail store can be identified as likely needing an employee on MPOS duty when a customer remains in a sector of the retail store for a period of time exceeding a threshold value (e.g., thr>three minutes).

In some scenarios, the information contained in the reports is also made available to store employees in possession of an MPOS device 112. MPOS devices are well known in the art, and therefore will not be described herein. Any known or to be known MPOS device can be used herein without limitation. However, as will be described below, each MPOS device 112 has installed thereon an MPOS software application implementing at least a portion of the present invention for facilitating management of MPOS services. The MPOS services can include, but are not limited to, services to process customer transactions for purchasing items at any location within the retail store which is accessible to a customer. In this regard, the MPOS device may include, but is not limited to, devices for controlling cash registers, payment card readers, receipt printers and/or barcode scanners. In one embodiment, the MPOS device is to be provided by software operating on specialized hardware, and could additionally provide for, without limitation, tracking and managing store-level inventory, ordering for inventory products and supplies and coordinating inventory with sales, as well as tracking employee information, such as employee hours and/or sales.

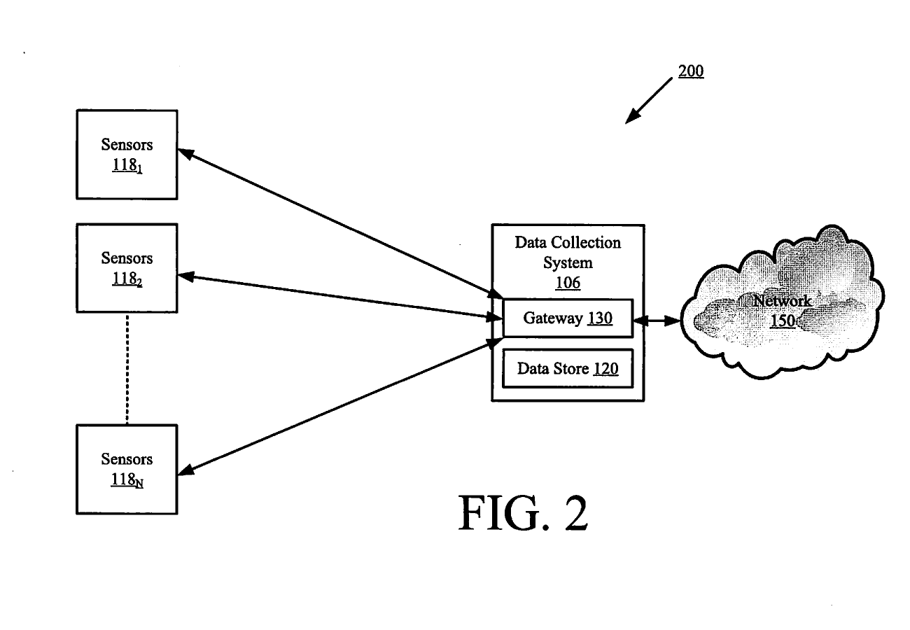

Referring now to FIG. 2, there is provided a schematic illustration of an exemplary network architecture 200 for the sensors 118 and DCS 106. As shown in FIG. 2, the network architecture 200 comprises a plurality of sensors 118₁, 118₂, . . . , 118_{N} in direct communication with the gateway 130 of the DCS 106. The direct communication can be achieved using any suitable communication protocol selected in accordance with a particular application. In this regard, the communications protocol may include, but is not limited to, an OSI stack protocol and/or a proprietary protocol. As known in the art, the OSI stack protocol includes data link layer protocols (e.g., IRR 802.2 protocols), network layer protocols (e.g., IPv6 protocols), and transport layer protocols (e.g., User Datagram protocols). In some scenarios, the communications protocol is selected such that the following network functions are provided: media access control and anti-collision functions; network access and security functions; network identification and timing functions; frequency synchronization functions; message delivery verification functions; device authentication functions; and/or message fragmentation and reassembly functions.

As shown in FIG. 2, the network topology of architecture 200 comprises a star network topology in which each sensor 118₁, 118₂, . . . , 118_{N} communicates directly to gateway 130 and no other network node. However, other network topologies can be used with the present invention without limitation. For example, the network topology can alternatively include a mesh topology or a mesh-star hybrid topology. In all cases, repeaters (not shown) may be provided between the sensors 118 and gateway 130 to facilitate indirect communications therebetween. The repeaters can include one or more of the sensors 118₁, 118₂, . . . , 118_{N} and/or devices separate and distinct from the sensors 118₁, 118₂, . . . , 118_{N}. Also, repeaters may serve as bridges between different channel sets used in different parts of the network, different protocols used for one or more OSI protocol layers, or message buffers to facilitate load balancing and message delivery guarantees.

During operation, the sensors 118₁, 118₂, . . . , 118_{N} may enter into a sleep mode for purposes of reserving power. If a given sensor (e.g., sensor 118₁) is in a sleep mode at the time when a message is sent thereto from the gateway 130, then another sensor (e.g., sensor 118_{N}) or repeater (not shown) which is in an awake mode may receive and temporarily store the message. Subsequently, the “awake” sensor (e.g., sensor 118_{N}) may detect when the “sleeping” sensor (e.g., sensor 118₁) transitions to its awake mode. Upon such detection, the “awake” sensor (e.g., sensor 118_{N}) forwards the message to the intended recipient sensor (e.g., sensor 118₁).

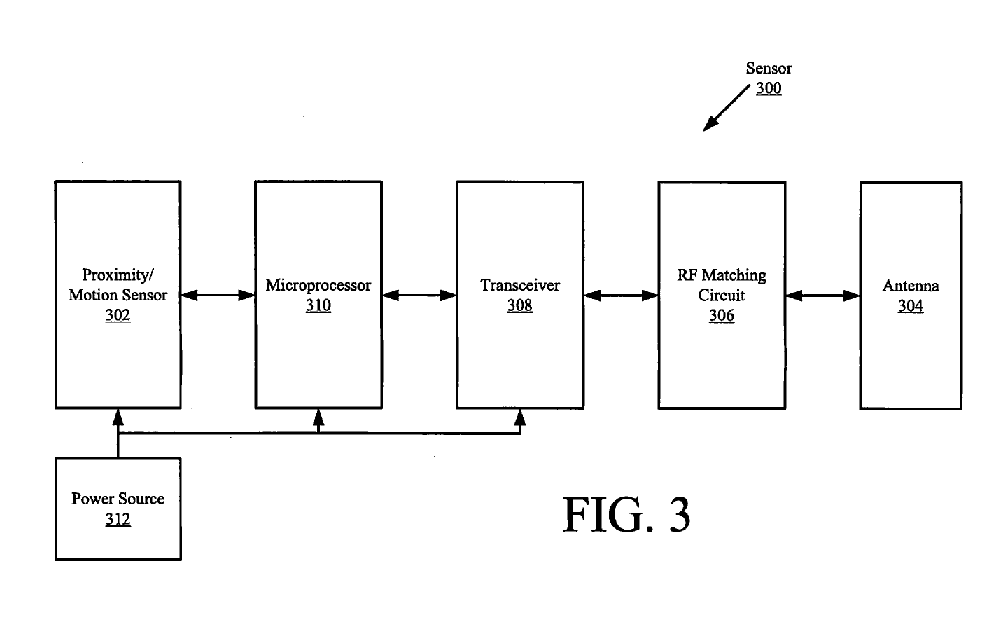

Referring now to FIG. 3, there is provided a block diagram of an exemplary architecture for a sensor 300 that is useful for understanding the present invention. Sensors 118, 118₁, 118₂, . . . , 118_{N} of FIGS. 1-2 can have an architecture that is the same as or similar to that of sensor 300. As such, the following discussion of sensor 300 is sufficient for understanding sensors 118, 118₁, 118₂, . . . , 118_{N}.

Notably, sensor 300 may include more or less components than those shown in FIG. 3. However, the components shown are sufficient to disclose an illustrative embodiment implementing the present invention. The hardware architecture of FIG. 3 represents one embodiment of a representative sensor configured to facilitate the provision of retail shopper surveillance. As such, sensor 300 of FIG. 3 implements at least a portion of a method for providing such retail shopper surveillance in accordance with embodiments of the present invention. Some or all components of sensor 300 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 3, sensor 300 comprises a proximity/motion sensor 302, a power source 312, a microprocessor 310, a transceiver 308, an RF matching circuit 306 and an antenna 304. Each of the components 302-312 is well known in the art, and therefore will not be described herein. Still, it should be understood that various sensor technologies may be employed in the implementation of the proximity/motion sensor 302. Such sensor technologies include, but are not limited to, acoustic wave technologies and/or infrared light reflection technologies. The power source 312 may include, but is not limited to, an energy harvesting device (e.g., a device that converts ultraviolet or visible light to electrical potential or current), and/or a rectification circuit driven by an external power source (e.g., an AC mains power source) or a battery (e.g., a dry cell or lithium ion battery) in conjunction with a capacitor.

As should be understood, a power amplifier and/or a low-noise amplifier may be added between the RF matching circuit 306 and the transceiver 308. Such amplifiers can be provided for purposes of increasing the effective communications range of the sensor 300 with other network nodes.

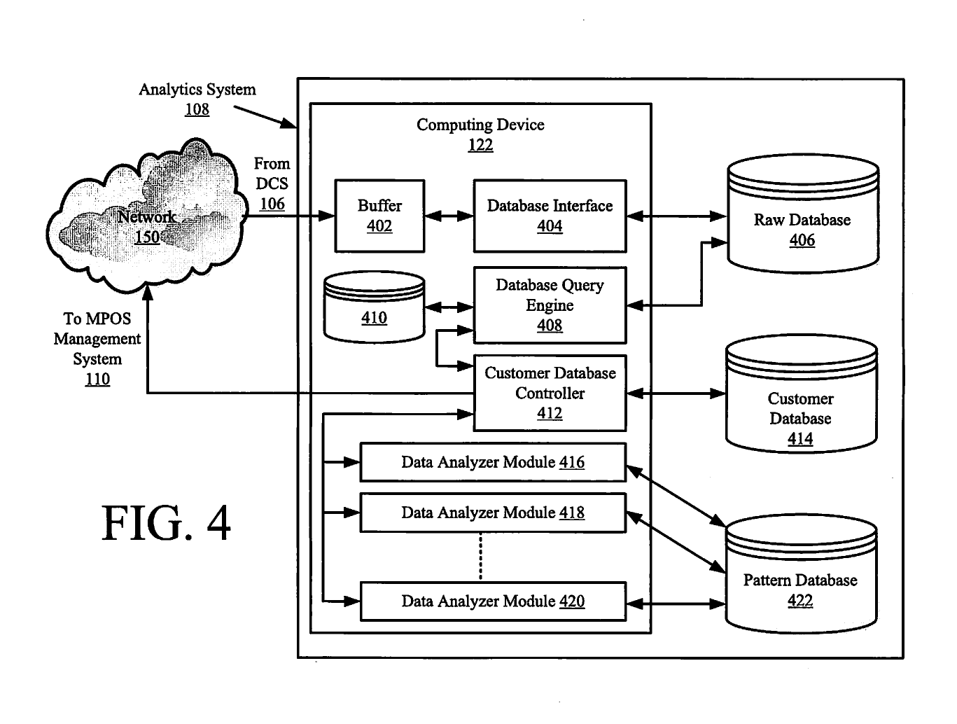

Referring now to FIG. 4, there is provided a detailed block diagram of an exemplary architecture for the analytics system 108 of FIG. 1. As described above, messages are sent from DCS 106 to the analytics system 108 via network 150. Upon receipt of a message, it is temporarily stored in buffer 402. In some scenarios, this might be accomplished with a simple linked or double-linked list of data structure objects, with each object recording for its corresponding message event, time of message arrival, type of message, network node identifier, network identifier, and/or sensor reading details (e.g., intensity or signal duration).

Thereafter, the message is forwarded to a database interface 404. At the database interface 404, certain information is parsed from the message. The parsed information is then used in an integrity checking process. Based on the results of the integrity checking process, the message may be discarded if it has incomplete data or data which is clearly outside allowed ranges. If the message is not to be discarded, then the database interface 404 performs operations to store the message in raw database 406, and delete the message from buffer 402. Raw database 406 may have data relating to messages received within past hours, days, months or even years. Such data facilitates an analysis of historical data to detect trends or patterns therein. The pattern detection can be achieved using pre-defined patterns, dynamically generated patterns, and/or learned patterns.

The Database Query Engine (“DQE”) 408 is configured to retrieve specific event sets matching specific database search criteria. The DQE 408 may temporarily cache results of searches in data cache 410 for reducing search time and query latency when many similar database searches are made in rapid succession from client module of the DQE 408.

The Customer Database Controller (“CDC”) 412 is configured to make raw data searches via DQE 408 and analyze the raw data using various data analyzer modules 416-420 to create and maintain the customer database 414. The data analyzer modules 416-420 can include, but are not limited to, recognition agents and/or rule engines. The data analyzer modules 416-420 may access and use pattern data stored in a pattern database 422. The pattern database can include patterns created external to the analytics system 108 or internal to the analytics system 108 based on results of customer traffic event trend analyses.

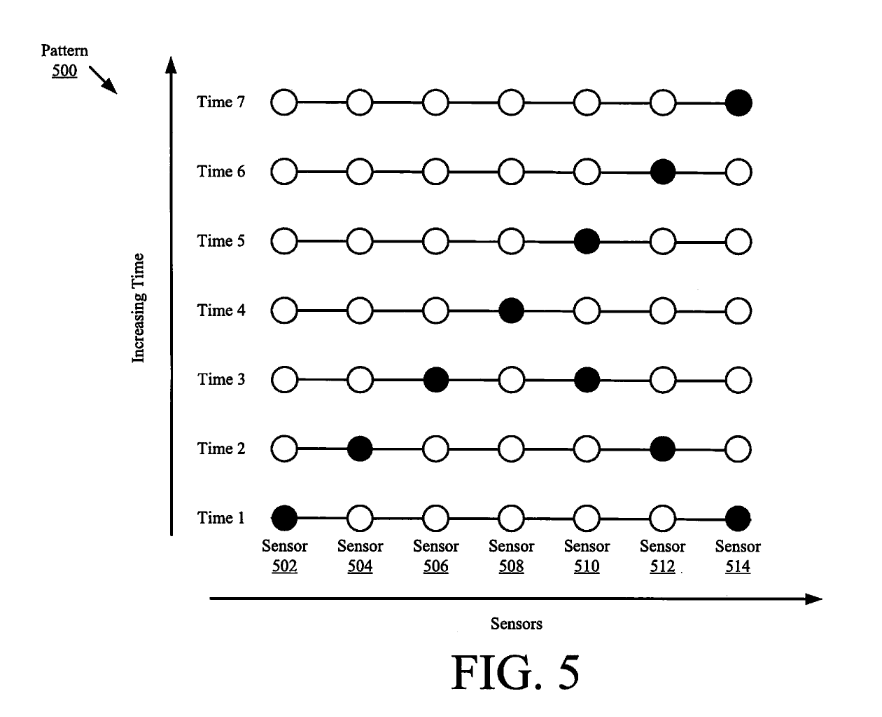

A schematic illustration that is useful for understanding an exemplary pattern 500 is provided in FIG. 5. Pattern 500 shows the scenario in which seven proximity sensors 502-514 are deployed in a retail store in a single line (e.g., along the length of an aisle). At time 1, sensors 502 and 514 report events. At time 2, sensors 504 and 512 report events. At time 3, sensors 506 and 510 report events. At time 4, sensor 508 reports an event. At time 5, sensor 510 reports an event. At time 6, sensor 512 reports an event. At time 7, sensor 514 reports an event. Pattern 500 may be entered into pattern database 422 as “pattern X1”=“two shoppers meet, join and proceed together”. Another pattern for exactly the same sequence of events could be labeled with additional alternative interpretations (e.g., “pattern X2”=“two shoppers meet, do not join, one proceeds while the other lingers” in the case where the sensor detects only moving persons).

One of the data analyzer modules 416-420 may be programmed for such pattern recognition. In this case, the data analyzer module (e.g., module 416) may maintain its own instance list (replication) of recent event messages (or use a master list maintained by customer database controller 412). When the data analyzer module finds a case in that list which matches a pattern from the pattern database 422, it may notify the customer database controller 412 of the match (or matches if the sequence of events matches more than one pattern). In turn, customer database controller 412 updates customer database 414 with the new information (e.g., “shoppers 6 and 11 associated through pattern X1 and X2”). Thereafter, an event message from sensors 506 and 510 may arrive at analytics system 108. In effect, a different data analyzer module (e.g., module 418) may alert the customer database controller 412 of a match between a pattern specified by the event messages and a different pattern from the pattern database 422. In response to the notification, the customer database controller 412 applies logic to resolve the previous question and make a conclusion that shoppers 6 and 11 are not together. More complex patterns and rules can be built up from composites of simpler patterns and rules.

The above discussion of pattern 500 is given only by way of example and is not intended to limit the type and variety of patterns used with the current invention. In fact, it should be noted that other expert system, machine learning or artificial intelligence design architectures may be alternatively or additionally employed here without loss of generality of the present invention. The analytics system 108 can make its results available to external devices or software modules (e.g., the MPOS management system 110) via network 150. For example, the results can be made available through a web service or service group maintained by the customer database controller 412. That is (in a restful web service approach), controller 412 has associated with it a root service URI which is used to discover and access a set of web services related to a number, location and status of each customer in a retail store. This web service interface corresponds to a network interface between analytics system 108 and the MPOS management system 110.

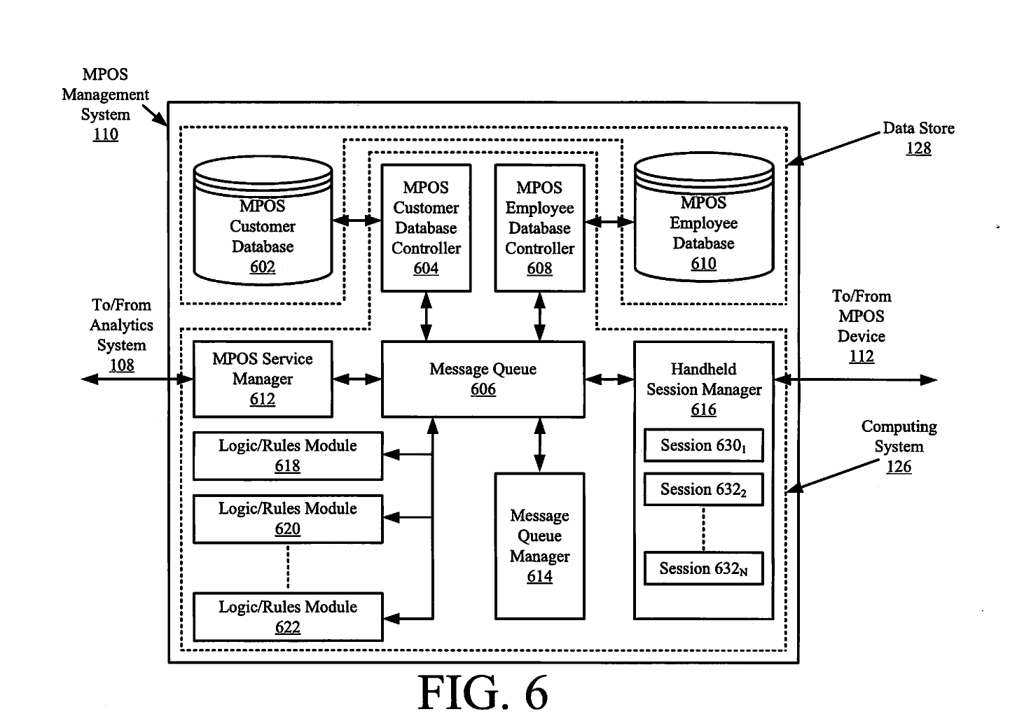

Referring now to FIG. 6, there is provided a schematic illustration of an exemplary architecture for the MPOS management system 110. The MPOS management system 110 is generally configured to facilitate the locating of customers in a retail store and/or the tracking of customer status. By tracking customer status and locations, a high level of customer service can be provided to the customers of a retail store. For example, the MPOS management system 110 can use such information to predict MPOS process demands and areas of a retail store where an MPOS will be needed.

As shown in FIG. 6, the MPOS management system 110 comprises an MPOS service manager 612. The MPOS service manager 612 is configured to initiate and supervise most of the activity associated with the MPOS process management. In some scenarios, the MPOS service manager 612 periodically checks for newly arrived customers, or checks that status of previously discovered customers using information maintained by the analytics system 108. The information can include, but is not limited to, a number of customers in a retail store, a location of each customer in the retail store, areas of the retail store which have been visited by each customer, items which each customer has placed in the respective shopping cart/basket, a total duration in which each customer has been in the retail store, a rate of travel for each customer (e.g., an average time it takes each customer to travel the length of an aisle), a number of areas of the retail store which have not been visited by each customer, a direction of travel of each customer, and/or an estimated time until each customer requires checkout. The information received from analytics system 108 can be stored in an MPOS customer database 602 and/or POS employee database 610. In this regard, the MPOS service manager 612 communicates customer related information to the MPOS customer database controller 604 via a message queue 606. The MPOS service manager 612 communicates employee related information to the MPOS employee database controller 608 via a message queue 606.

The MPOS management system 110 also comprises a plurality of logic/rule modules 618, 620, . . . , 622. These modules 618, 620, . . . , 622 are configured to identify the following from information received from the analytics system 108 and/or MPOS devices: customers who have requested MPOS service; customers who are likely to require MPOS service in the near future (e.g., within the next N minutes); and/or employees who are or should be available to provide MPOS service. In some scenarios, the information needed to make such identifications is provided to the modules by the MPOS service manager 612, the MPOS customer database controller 604, and/or by the MPOS employee database 610.

In some scenarios, module 618 comprises logic to identify a customer as likely in impending need of MPOS service with “medium likelihood” anytime that customer visits a store sector for more than three minutes, and with “high likelihood” when the customer stays in the same sector for more than seven minutes. Accordingly, module 618 may routinely query the MPOS customer database 602 and send an alert to the MPOS service manager 612 whenever its rules are satisfied (i.e., it identifies a customer as likely in need of MPOS service). The other modules 620, . . . , 622 may apply other rule sets and logic for other tasks.

The MPOS service manager 612 may further communicate messages to and from MPOS devices of employees via the message queue 606 and the handheld session manager 616. Whenever an employee has an MPOS application running on his/her MPOS device, the employee has corresponding and active sessions 632₁, 632₂, . . . , or 632_{N} in handheld session manager 616, as will be described in detail below. Associated with each session 632₁, 632₂, . . . , 632_{N} is a session state, which would include a full description of the corresponding MPOS device status with respect to an MPOS service (i.e., not currently engaged in MPOS transaction, MPOS transaction requested/pending, MPOS transaction in process, MPOS service temporarily unavailable, etc . . . ). The session states maintained by handheld session manager 616 in its own data store (not shown), but may be accessed and monitored by MPOS service manager 612 via message queue 606.

A key function of the MPOS service manager 612 is to maintain a knowledge of which employees are currently on MPOS duty, which employees are currently involved in an MPOS transaction, and which employees are available for and best suited to service the next MPOS request. This knowledge is obtained by a combination of queries to the databases 602 and 610, messages to the handheld service manager 616, and messages to the various logic/rules modules 618-622.

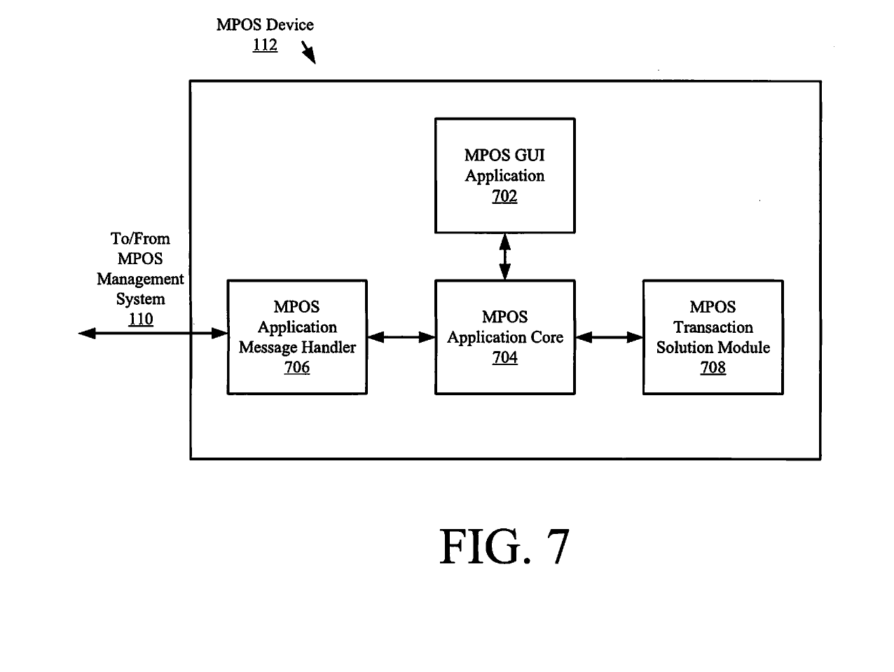

Referring now to FIG. 7, there is provided a schematic illustration of an exemplary architecture for the MPOS device 112 of FIG. 1. MPOS device includes, but is not limited to, a handheld communication device, a portable communication device, a smart phone, a cellular phone, a handheld computer, a personal digital assistant, and/or a tablet. All of the listed devices are well known in the art, and therefore will not be described in detail herein. However, it should be understood that the MPOS device 112 has a novel MPOS software application installed thereon which implements the present invention. The novel MPOS software application will now be described in detail.

The MPOS software application can run on top of an operating system of the MPOS device 112, and communicate with the session manager 616 of the MPOS management system 110 via a network link. The MPOS software application comprises an MPOS GUI application 702, an MPOS application core 704, an MPOS application message handler 706 and an MPOS transaction solution module 708. The MPOS application core 704 is configured to manage activities of the MPOS device 112, but uses MPOS transaction solution module 708 to carry out financial transactions. Activating or “turning on” the MPOS application is achieved by running and initializing the MPOS application core 704. When this occurs, the MPOS application core 704 sends a message indicating its new state to the session manager 616 of the MPOS management system 110 via the MPOS application message handler 706 and network link. Each time a change in the state of the MPOS application core 704 occurs, the MPOS application core 704 sends a new state update message to the MPOS application message handler 706.

The MPOS GUI application 702 facilitates user software interactions between a store employee and the MPOS software application. In some scenarios, the GUI provided by the MPOS GUI application 702 includes, but is not limited to, a drop down menu. The menu may include a first selectable item by which the store employee may manually update the status of the MPOS software application (e.g., switch to “MPOS service temporarily unavailable” mode if the employee is busy with a personal or store task unrelated to an MPOS activity). Another item selection of the menu may allow the store employee to activate the MPOS transaction solutions module 708. At the time of activation of the MPOS transaction solutions module 708, the MPOS application core 704 switches its state to an “MPOS transaction in process” state, sends a state change message to the session manager 616 of the MPOS management system 110, disables the MPOS GUI application 702, activates financial transaction operations thereof or of a third party module, halts other operations, and/or awaits a result from the financial transaction operations. Upon receipt of the result from the financial transaction operations, the MPOS GUI application 702 is re-enabled. Also, the state of the MPOS transaction solutions module 708 is changed to a “not currently engaged in an MPOS transaction” state. Again, a state changed message is sent from the MPOS transaction solutions module 708 to the session manager 616 of the MPOS management system 110.

The MPOS GUI application 702 is configured to display a plurality of GUIs to a user of the MPOS device 112. One such GUI comprises a store map representation showing a last known location of each customer and/or store employee within a retail store. The store map representation serves as an interface or point of access of detailed information on each customer and/or store employee referenced therein. That is, by zooming in on a particular location (individual) and touching the icon representing the individual's location, detailed information is displayed to the user of the MPOS device 112. For example, in the case of a customer, the detailed information may include, but is not limited to, the total duration of time in which the customer has been in the retail store, and/or a total duration of time in which the customer has been in a particular sector of the retail store. In the case of a store employee, the detailed information may include, but is not limited to, a name of the store employee and/or a current MPOS process status.

The MPOS device 112 is not limited to the architecture shown in FIG. 7. For example, the MPOS device 112 may further comprise an MPOS process management portal (not shown) serving as a human interface and manual management platform for the MPOS management system 110. The MPOS process management portal could be implemented as an application running on an electronic device of a store manager (or other key employee's electronic device), and capable of sending messages via a network link to the session manager 616 of the MPOS management system 110. The session manager 616 would be capable of supporting a corresponding special monitoring/management session with functionality above and beyond the functionality available in a normal session therein. The MPOS process management portal could also send messages to specific store employee via the session manager 616, either in retail time or according to a schedule. For example, the MPOS process management portal could send planned reminder messages from a store manager to specific individual store employees or groups of store employees. The reminder messages could be sensitive to and triggered by a particular event, and sent automatically on occurrence of the event.

A logic/rules module might be implemented in the MPOS management system 110 which identifies a specific situation in which a certain (threshold) number of customers have been inside the retail store for a (threshold) period of time. At that threshold number and time, all store employees currently scheduled for MPOS duty are either (1) listed in the MPOS employee database as temporarily unavailable or (2) not listed with an active session in session manager 616 (e.g., indicating that their electronic devices are not powered or currently running the MPOS application).

As evidence from the above discussion of the present invention, it provides a platform by which the following activities can be conducted. First, a store employee may be shown information specifying locations of customers inside a retail store which are most likely to need MPOS assistance in the immediate future, as determined by analytics and rule engines running in the MPOS management system 110. This information can be presented to the store employee via a GUI (e.g., via a GUI on-screen map, icon and/or text) of the MPOS application combined with messages from an MPOS management system.

Second, the GUI elements' properties (e.g., on-map icons, icon colors, text colors, etc.) may be used along with analytics based either on: (1) customer identity, behavior, time and event context; and/or (2) a combination of two or more parameters of (1). As a result, the GUI provides store employees with information that indicates which customers are most likely to require MPOS service in the immediate future. For example, if a customer has been in the retail store for a relatively long period of time and video analytics of the analytics system 108 determine that the customer has several items in his/her shopping cart, then an icon representing that customer on the MPOS application GUI map would be large and red rather than small and yellow or white.

Third, the store employee may use the GUI with its exhibited information on customer locations to decide where they might best locate themselves to provide the fastest MPOS service when a need arises. Fourth, the store employee may be assigned routes to walk through the retail store and shown these routes on the GUI map displayed on his/her handled device. The routes may be assigned automatically, by the logic/rules modules 618-622 of the MPOS manage system 110, based on conditions and the number of store employees current on MPOS duty. In determining the routes, the logic/rules modules 618-622 may query the MPOS customer database 602 and/or the MPOS employee database 610 to ascertain where the customers and other store employees on MPOS duty are current located. Thereafter, the logic/rules modules 618-622 may assign complementary routes to the set of store employees on MPOS duty.

Fifth, a store manager can send MPOS related, context-specific messages to store employees on MPOS duty. The store manager may also schedule custom messages to be sent automatically when triggered by an event. The event may be defined in terms of a combination of shopper group status conditions and employee group status conditions, as determined by analytics system 108.

Sixth, responsiveness of any particular store employee or group of store employees to MPOS service demands may be determined and tracked over a period of time, and qualified in the context of customer location trends, employee location trends, employee task status, etc. The data history analytics is enabled by the combination of customer location trends, employee location trends, and MPOS end node application status trends.

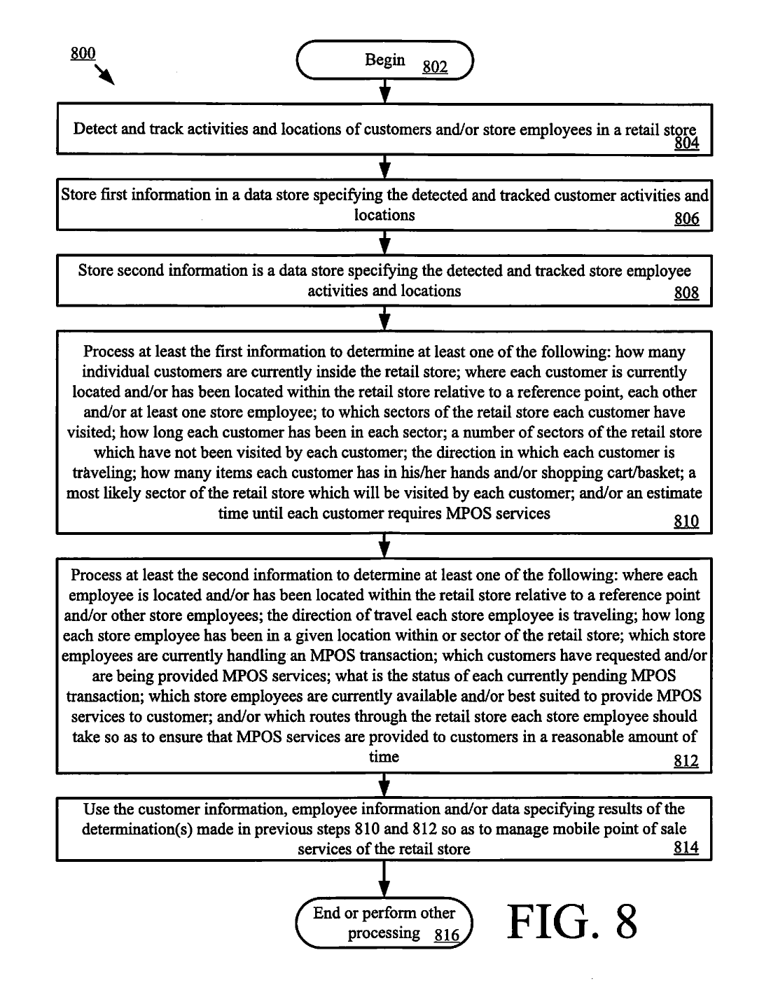

Referring now to FIG. 8, there is provided a flow diagram of an exemplary method 800 for managing MPOS services of a retail store. Method 800 begins with step 802 and continues with step 804. Step 804 involves detecting and tracking activities and locations of customers and/or store employees in the retail store. Next in steps 806 and 808, first and second information is stored in at least one data store. The first information includes, but is not limited to, information specifying the detected and tracked store employee activities and locations. The second information includes, but is not limited to, information specifying the detected and tracked store employee activities and locations.

The first and second information may then be processed to make one or more determinations, as shown by steps 810 and 812. For example, the first information can be processed to make one or more of the following determinations: how many individual customers are currently inside the retail store; where each customer is currently located and/or has been located within the retail store relative to a reference point, each other and/or at least one store employee; to which sectors of the retail store each customer and/or store employee have visited; how long each customer and/or employee has been in each sector; a number of sectors of the retail store which have not been visited by each customer; the direction in which each customer is traveling; how many items each customer has in his/her hands and/or shopping cart/basket; a most likely sector of the retail store which will be visited by each customer; and/or an estimate time until each customer requires MPOS services. The estimate time can be determined using the customer information and/or historical data relating to previous shopping activities by the customer within the retail store.

The second information can be processed to make one or more of the following determinations: where each employee is located and/or has been located within the retail store relative to a reference point and/or other store employees; the direction of travel each store employee is traveling; how long each store employee has been in a given location within or sector of the retail store; which store employees are currently handling an MPOS transaction; which customers have requested and/or are being provided MPOS services; what is the status of each currently pending MPOS transaction; which store employees are currently available and/or best suited to provide MPOS services to customer; and/or which routes through the retail store each store employee should take so as to ensure that MPOS services are provided to customers in a reasonable amount of time.

Upon competing steps 810 and 812, step 814 is performed where the customer information, employee information and/or data specifying result(s) of the determination(s) is(are) used to manage MPOS services of the retail store. For example, based on the customer information and/or results of at least one of the above listed determinations, customer demands for the MPOS devices can be predicted. Additionally or alternatively, the customer demands can be predicted using a pattern of movement detected for each customer. The pattern of movement can include based on the customer information and calibration patterns. The calibration patterns can include pre-defined calibration patterns and/or learned calibrations patterns. The customer demands may further be predicted using a result of a determination as to whether a period of time in which a customer has been in a given sector of the retail store exceeds a threshold value. If the period of time exceeds the threshold value, then an employee can be deployed to the given sector of the retail store. Next, step 816 is performed where method 800 ends or other processing is performed.

All of the apparatus, methods, and algorithms disclosed and claimed herein can be made and executed without undue experimentation in light of the present disclosure. While the invention has been described in terms of preferred embodiments, it will be apparent to those having ordinary skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those having ordinary skill in the art are deemed to be within the spirit, scope and concept of the invention as defined.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

We claim:

1. A method for managing Mobile Point Of Sale (“MPOS”) services of a retail store, comprising:
obtaining customer information specifying sensed activities and locations of customers currently present in the retail store;
predicting customer demands of the MPOS services based on the customer information, where the MPOS services facilitate a purchase transaction by a customer for purchasing at least one item offered for sale within the retail store; and
managing the MPOS services based on the predicted customer demands.

2. The method according to claim 1, further comprising making at least one determination of the following determinations based on the customer information:
how many individual customers are currently inside the retail store;
where each customer is currently located and/or has been located within the retail store relative to a reference point, each other and/or at least one store employee;
which sectors of the retail store have been visited by each customer;
how long has each customer been in each sector of the retail store;
how many sectors of the retail store have not been visited by each customer;
which direction each moving customer is traveling;
how many items offered for sale by the retail store are currently possessed by each customer; and
a most likely sector of the retail store which will be visited by each customer.

3. The method according to claim 2, wherein the customer demands are further predicted based on results of the determination.

4. The method according to claim 1, further comprising estimating a time until each customer requires the MPOS services based on at least one of the customer information and historical data relating to previous shopping activities by the customer within the retail store.

5. The method according to claim 1, further comprising detecting a pattern of movement for each customer based on the customer information and calibration patterns.

6. The method according to claim 5, wherein the customer demands are further predicted based on the pattern of movement detected for each customer.

7. The method according to claim 1, wherein the customer demands of the MPOS services are predicted by determining if a period of time in which a customer has been in a given sector of the retail store exceeds a threshold value.

8. The method according to claim 7, further comprising deploying an employee of the retail store to the given sector when it is determined that the period of time exceeds the threshold value.

9. The method according to claim 1, further comprising:
obtaining employee information specifying activities and locations of employees currently present in the retail store;
wherein the MPOS services are further managed based on the employee information.

10. The method according to claim 9, further comprising making at least determination of the following determinations based on the employee information:
where each employee is located and/or has been located within the retail store relative to a reference point, other store employees, and/or at least one customer;
which direction each moving store employee is traveling;
how long each store employee has been in a given location within or sector of the retail store;
which store employees are currently handling an MPOS transaction;
which customers have requested MPOS services from a store employee;
which customers are currently being provided MPOS services by respective store employees;
what is a status of each currently pending MPOS transaction;
which store employees are currently available and/or best suited to provide MPOS services to customer; and
which routes through the retail store each store employee should take so as to ensure that MPOS services are provided to customers in a reasonable amount of time.

11. A system, comprising:
at least one electronic circuit configured to
obtain customer information specifying sensed activities and locations of customers currently present in a retail store;
predict customer demands of MPOS services based on the customer information, where the MPOS services facilitate a purchase transaction by a customer for purchasing at least one item offered for sale within the retail store; and
manage the MPOS services based on the predicted customer demands.

12. The system according to claim 11, wherein management of the MPOS services is achieved using a result of at least one determination of the following determinations made based on the customer information:
how many individual customers are currently inside the retail store;
where each customer is currently located and/or has been located within the retail store relative to a reference point, each other and/or at least one store employee;
which sectors of the retail store have been visited by each customer;
how long has each customer been in each sector of the retail store;
how many sectors of the retail store have not been visited by each customer;
which direction each moving customer is traveling;
how many items offered for sale by the retail store are currently possessed by each customer; and
a most likely sector of the retail store which will be visited by each customer.

13. The system according to claim 11, wherein the customer demands are further predicted based on results of the determination.

14. The system according to claim 11, wherein the electronic circuit is further configured to estimate a time until each customer requires the MPOS services based on at least one of the customer information and historical data relating to previous shopping activities by the customer within the retail store.

15. The system according to claim 11, wherein the electronic circuit is further configured to detect a pattern of movement for each customer based on the customer information and calibration patterns.

16. The system according to claim 15, wherein the customer demands are further predicted based on the pattern of movement detected for each customer.

17. The system according to claim 11, wherein the customer demands of the MPOS services are predicted by determining if a period of time in which a customer has been in a given sector of the retail store exceeds a threshold value.

18. The system according to claim 17, wherein an employee of the retail store is deployed to the given sector when it is determined that the period of time exceeds the threshold value.

19. The system according to claim 11, wherein the MPOS services are further managed based on employee information specifying activities and locations of employees currently present in the retail store.

20. The system according to claim 19, wherein management of the MPOS services is achieved using a result from at least determination of the following determinations made based on the employee information:
where each employee is located and/or has been located within the retail store relative to a reference point, other store employees, and/or at least one customer;
which direction each moving store employee is traveling;
how long each store employee has been in a given location within or sector of the retail store;
which store employees are currently handling an MPOS transaction;
which customers have requested MPOS services from a store employee;
which customers are currently being provided MPOS services by respective store employees;
what is a status of each currently pending MPOS transaction;
which store employees are currently available and/or best suited to provide MPOS services to customer; and
which routes through the retail store each store employee should take so as to ensure that MPOS services are provided to customers in a reasonable amount of time.
